(19) United States
(12) Patent Application Publication
(10) Pub. No.: US 2008/0049447 A1
(43) Pub. Date: Feb. 28, 2008

(54) Edge lighted display system having multiple display faces

(76) Inventor: Hae-Ryong Jung, Arlington, VA (US)

Correspondence Address: HAE-RYONG JUNG, 2111 JEFFERSON DAVIS HWY., 119-N, ARLINGTON, VA, 22202, US

(21) Appl. No.: 11/889,989

(22) Filed: Aug. 20, 2007

(30) Foreign Application Priority Data
Aug. 22, 2006 (KR) 10-2006-0079222

(51) Int. Cl. F21V 8/00

(52) U.S. Cl. 362/612

(57) ABSTRACT

The present invention relates to an edge lighted display system having multiple display faces. The edge lighted display system having multiple display faces includes a plurality of light guide plates respectively having both sides bent at a predetermined angle, a cylindrical or polyhedral pillar-shaped three-dimensional structure formed by bent distal ends of the light guide plates, LED light source assemblies linearly arranged at the ends of the junctions of the light guide plates, so that light energy from light sources can be incident on two sheets of the light guide plates simultaneously, covering plates securely mounted on top and bottom surfaces of a three-dimensional structure formed by interconnecting the plurality of light guide plates, a thin opaque or black board disposed on an inner wall surface of the light guide plate, and thin transparent graphic elements adhered on an outer wall surface of the light guide plate.

### BACKGROUND OF THE INVENTION

1. Field of the Invention

The present invention relates to an edge lighted display system having multiple display faces, and more particularly, to an edge lighted display system having multiple display faces which can be used as a combined decoration and illumination light and an advertisement medium, in which a rough surface is formed where light energy radiated from a light source undergoes repetitive total reflection within a light guide plate and diffused reflection can occur as the light energy is scattered while passing through the light guide plate, or graphics are formed where diffused reflection can occur, so that that part looks remarkably.

2. Background of the Related Art

In general, an illumination system can be used as a general illumination light for illuminating surroundings by using light of a light source, or can be used as a display system for advertisement in which the effect of advertisement while making distinguished only a specific portion can be obtained.

If the illumination system is to be used as an illumination light or a display system for advertisement, an effort has been made to guide light of a light source to a desired direction or location or form a path of light.

Thus, Korean Patent Registration No. 168711 (issued to Jeong Hae-Ryong), Korean Patent Laid-Open Publication No. 10-2004-0063887, Korean Utility Model Laid-Open Publication No. 20-0407883, U.S. Pat. No. 6,240,664, U.S. Pat. No. 5,625,968, U.S. Pat. No. 5,390,436, PCT/FR98/02036, PCT/JP05/010872, etc. have been proposed.

In the conventional edgelit systems, however, graphics displaying on one light guide plate could be seen from one fixed direction. In order to expand the base of its application to a decorative illumination structure and make graphics distinguished by precluding unnecessary portions other than displayed graphics from the visual field of a viewer, it has been necessary to form a polyhedron display having a shape as one three-dimensional structure.

Further, in order to obtain a more beautiful visual effect by combing several colors, attract attention of viewers more effectively by welding a projected graphic board to a display surface using a solvent, and fabricate a display having a robust three-dimensional polyhedron structure, there has been a need for a robust many-sided display system that can be hung from the ceiling, such as a general illumination structure, can be attached to a wall surface by using brackets, or can be put up as a stand.

Thus, it has been necessary for the display system to serve as both a decorative illumination structure and an advertisement medium for displaying graphics to several viewers simultaneously at a place where a more beautiful atmosphere is to be strengthened with a low intensity of illumination.

### SUMMARY OF THE INVENTION

Accordingly, the present invention has been made in view of the above problems occurring in the prior art, and it is an object of the present invention to provide an edge lighted display system having multiple display faces which can be used as a combined decoration and illumination light and an advertisement medium, and in which a rough surface are formed where light energy radiated from a light source undergoes repetitive total reflection within a light guide plate and diffused reflection can occur as the light energy is scattered while passing through the light guide plate is formed, or graphics where diffused reflection can occur, so that the graphic part looks remarkably.

To achieve the above object, an edge lighted display system having multiple display faces of the present invention includes a plurality of light guide plates respectively having both sides bent at a predetermined angle, a cylindrical or polyhedral pillar-shaped three-dimensional structure formed by bent distal ends of the light guide plates, LED light source assemblies linearly arranged at the ends of the junctions of the light guide plates, so that light energy from light sources can be incident on two sheets of the light guide plates simultaneously, covering plates securely mounted on top and bottom surfaces of a three-dimensional structure formed by interconnecting the plurality of light guide plates, a thin opaque or black board disposed on an inner wall surface of the light guide plate, and thin transparent graphic elements adhered on an outer wall surface of the light guide plate.

### BRIEF DESCRIPTION OF THE DRAWINGS

Further objects and advantages of the invention can be more fully understood from the following detailed description taken in conjunction with the accompanying drawings in which:

FIG. 1 is a cross-sectional view of an edge lighted display system having multiple display faces in which a group of three linear light sources (LEDs) and three sheets of light guide plates are combined according to an embodiment of the present invention;

FIG. 2 is a cross-sectional view of an edge lighted display system having multiple display faces in which four linear tube-shaped light sources and four sheets of light guide plates are combined according to another embodiment of the present invention;

FIG. 3 is a cross-sectional view of an edge lighted display system having multiple display faces, which has a group of two light sources (LEDs) and two sheets of light guide plates of a curved surface and has as a whole the same shape as that of a cylindrical illumination structure according to still another embodiment of the present invention;

FIG. 4a is a front view showing a state where a character graphic board is installed on the wall surface of a light guide plate and hung from the ceiling in an edge lighted display system having multiple display faces in which a group of two linear light sources (LEDs) and two sheets of light guide plats having a plane are combined in accordance with an application of the present invention;

FIG. 4b is a cross-sectional view of FIG. 4a;

FIG. 4c is an expanded cross-sectional view of a part of FIG. 4b;

FIG. 5 is a perspective view showing a state where a transparent graphic board welded to the surface of a light guide plate looks better while rotating the whole edge lighted display system having multiple display faces formed of one square pillar-shaped three-dimensional structure in accordance with another application of the present invention; and

FIG. 6 is a perspective view showing a state where an edge lighted display system having multiple display faces formed of a triangular pillar-shaped three-dimensional structure is hung from the ceiling according to still another embodiment of the present invention.

### DETAILED DESCRIPTION OF THE PREFERRED EMBODIMENT

The present invention will now be described in detail in connection with specific embodiments with reference to the accompanying drawings.

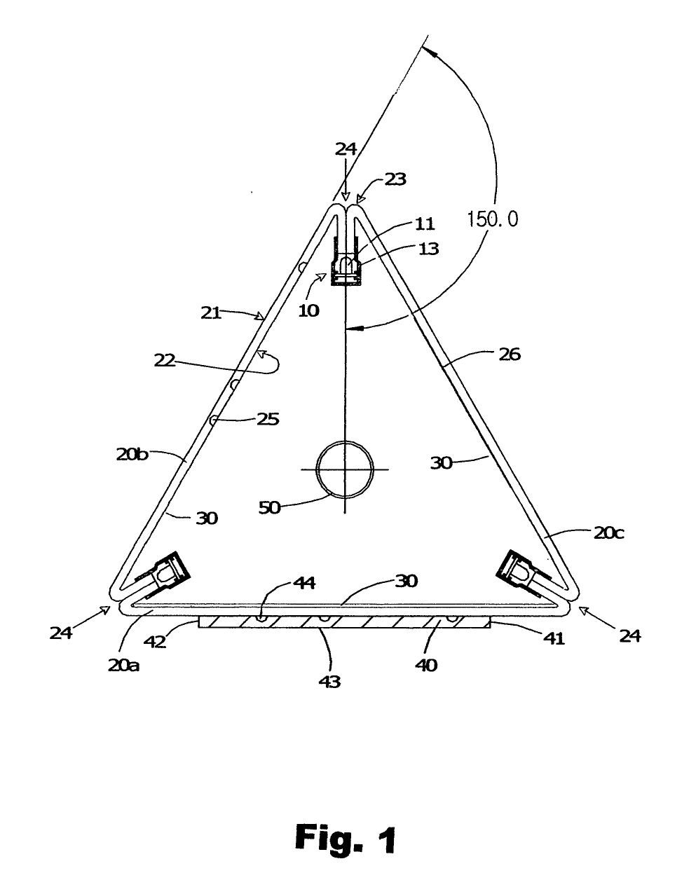

FIG. 1 is a cross-sectional view of an edge lighted display system having multiple display faces in which a group of three linear light sources (LEDs) and three sheets of light guide plates are combined according to an embodiment of the present invention.

As shown in FIG. 1, in order to form one system having plural display surfaces, both ends of each of three sheets of light guide plates 20a, 20b and 20c are bent 150 degrees, and LED light source assemblies 10, which are arranged in a straight line, are combined with the light guide plates 20a, 20b and 20c, respectively, thus forming a display system having a triangular pillar-shaped three-dimensional structure.

A LED strip linearly arranged in a printed circuit board (hereinafter, referred to as a “PCB”) on which a LED is printed as a light source 11 is supported within a light source mechanism housing 13 of each LED light source assembly 10, so that light energy radiated from the light source 11 passes through the distal end of the light guide plate 20 and then effectively enters therein.

Housings 13 are disposed at the LED light source assemblies 10, respectively, such that the light sources 11 of the LED light source assemblies 10 direct toward the distal ends of every two sheets of the light guide plates 20a and 20b, 20b and 20c, 20c and 20a, which are bent together and contact each other. Thus, the whole light energy generated from the light sources 11 can be induced to the insides of the light guide plates 20a, 20b and 20c.

A PCB (not shown), which physically supports the LED (that is, the light source 11) and performs electrical connection, is built in the housing 13.

Light generated from the light source 11 of the LED light source assembly 10 has directivity unlike a fluorescent lamp (that is, a tubular light source). This makes it unnecessary to have the PCB built in the housing 13. In this case, the PCB can be fixed to the rear surface of the PCB by using a robust clip that can be accessed to the end of the light guide plate, so that the PCB is coupled to the light guide plate by elasticity of a material to form the clip.

Light energy that travels causes diffused reflection at a bent portion 23 of the bent light guide plate 20, and a scattering phenomenon of light occurs at the bent portion 23. A ridge 24 of a structure where the two bent portions are combined emits light and its emission portion serves as a contour of graphics, so that the contour is seen as a part of graphics. Some light energy is consumed due to the scattering phenomenon of light at a ridge 24, but reaches the central portion of a graphic board 40 along the light guide plate 20. Thus, there is no problem in that graphics are emitted.

In relation to the light source 11, a light source in which a plurality of LED lamp point light sources are arranged linearly, as shown in FIG. 1, can be used as one linear light source.

A wavelength of the light energy radiated from the light source has a spectrum of a unique wavelength according to an emission characteristic of its emission material or a stimulus method of causing emission, and an unlimited combination is possible in the combination of colors or the arrangement of an order.

Further, if several on/off methods are combined, a change of several visual effects can be produced through a change of numerous colors and a combination of the on/off methods.

As one embodiment, in the event that the colors of the two light source disposed on both sides of one light guide plate 20 are red and blue, when a light beam that proceeds through total reflection within the light guide plate meets a rough surface, scattered light energy of red light is prominent as the light beam approaches the red light source, red light energy is prominent as the light beam approaches the blue light source, the degree of mutual interference of the two color lights becomes identical at its center, so that it looks purple and distributions of a gradual change of a beautiful color appear accordingly.

In the same manner, when colors of three light sources are differently arranged, an interference phenomenon occurs due to a combination of different colors according to a distance at each light source. Thus, the three light sources can be designed such that specific scattering of light can be generated according to the graphic board 40 disposed on the surface of the light guide plate 20, producing graphics that can give a high level of a visual feeling of aesthetic appreciation. Further, when linear arrangement of a dot light source, such as a LED, is used as a light source, an interference effect of finer light can be produced by combining the colors of the respective dot light sources themselves.

Opaque or black thin boards 30 are formed on light guide plate interior walls 22 so that the inside of a structure is precluded from being seen externally and shining graphics can be monitored over a black background color, making the graphic board 40 look better.

In FIG. 1, the graphic board 40 disposed on a light guide plate exterior wall 21 is formed of a transparent board material, which is the same as that of the light guide plate 20. The graphic board 40 is welded to the light guide plate exterior wall 21, so that a part of light energy, which travels the light guide plate, enters the inside of the graphic board 40. Thus, diffused reflection occurs on roughly cut sections 41,42 and a surface 43 of a roughly processed graphic board 40, and both the attached graphic side and the surface emit light, so that graphics are shined in a three-dimensional manner.

In this case, a method of roughly processing the surface of a smooth graphic board 40 can include fabricating a rough surface simply and cheaply by using a spray device for giving shock with grains of sand sprayed at high speed, a method of corroding the surface of the light guide plate chemically, etc. However, the methods are merely reference information related to the present invention.

In the transparent graphic board 40 disposed on the surface of the light guide plate 20a shown in FIG. 1, since the sections 41,42 and the surface 43 are roughly processed as mentioned earlier, the scattering phenomenon of light occurs. In this case, when the surface 43 is not roughly processed, engravings 44 are formed on the welded surface of the graphic board 40 along the contour of graphics, so that that part becomes prominent in order to view the graphics more clearly.

Meanwhile, in FIG. 1, a method of directly forming engravings 25 on the light guide plate 20 so that light is further emitted from the portions is indicated in the light guide plate 20b. A method of attaching a cut white film 26 is displayed in the light guide plate 20c.

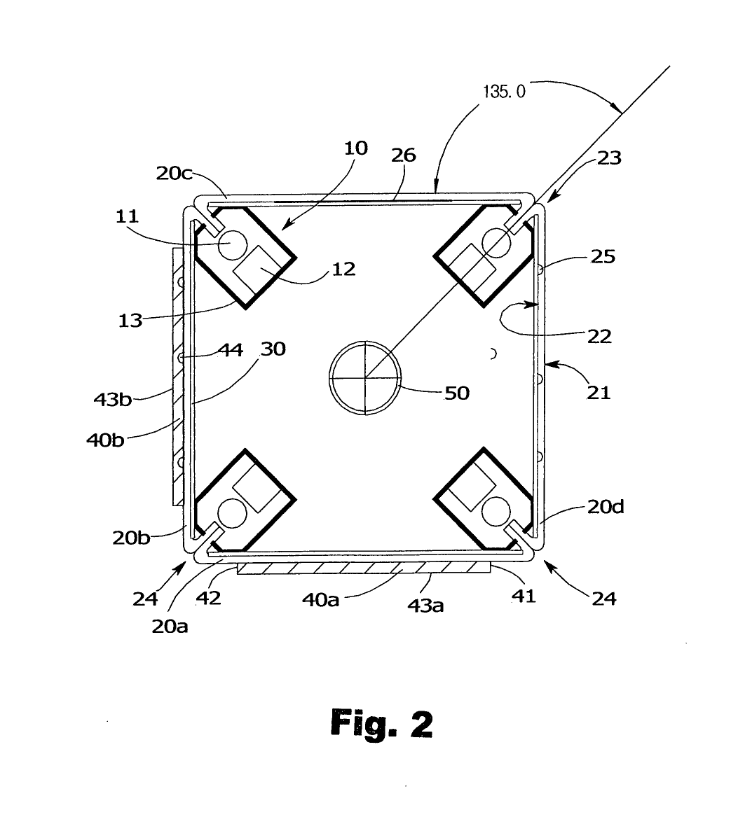

FIG. 2 is a cross-sectional view of an edge lighted display system having multiple display faces in which four linear tube-shaped light sources and four sheets of light guide plates are combined according to another embodiment of the present invention.

In FIG. 2, there is shown a display system having many-sided surfaces, which constitutes a square pillar-shaped three-dimensional structure in such a manner that both ends of each of four sheets of light guide plates 20a, 20b, 20c and 20d are bent 135 degrees so that bent portions of every two sheets of light guide plates 20a and 20b, 20b and 20c, 20c and 20d, and 20d and 20a are brought in contact with each other.

A LED strip in which a linear fluorescent lamp tube having a relatively small diameter, as a light source 11, is linearly arranged on a lighting device 12 is supported within a light source mechanism housing 13 of each LED light source assembly 10, so that light energy radiated from the light source 11 passes through the distal end of the light guide plate 20 and then effectively enters therein.

A housing 13 is disposed at the LED light source assembly 10 such that the light source 11 of the LED light source assembly 10 directs toward the distal ends of every two sheets of the light guide plates 20a and 20b, 20b and 20c, 20c and 20a, which are bent together and contact each other. Thus, the whole light energy generated from the light source 11 can be induced to the inside of the light guide plates 20a, 20b and 20c.

Since the light source 11 of the LED light source assembly 10 is a fluorescent lamp (that is, a tubular light source), a clip formed on both sides of the housing 13 is coupled to the light guide plate 20.

Light energy that travels causes diffused reflection at a bent portion 23 of the bent light guide plate 20, and a scattering phenomenon of light occurs at the bent portion 23. A ridge 24 of a structure where the two bent portions are combined emits light and its emission portion serves as a contour of graphics, so that the contour is seen as a part of graphics. Some light energy is consumed due to the scattering phenomenon of light at a ridge 24, but reaches the central portion of a graphic board 40 along the light guide plate 20. Thus, there is no problem in that graphics are emitted.

A wavelength of the light energy radiated from the light source 11 has a spectrum of a unique wavelength according to an emission characteristic of its emission material or a stimulus method of causing emission, and an unlimited combination is possible in the combination of colors or the arrangement of an order.

Further, if several on/off methods are combined, a change of several visual effects can be produced through a change of numerous colors and a combination of the on/off methods.

In the same manner, when colors of three light sources are differently arranged, an interference phenomenon occurs due to a combination of different colors according to a distance at each light source. Thus, the three light sources can be designed such that specific scattering of light can be generated according to a graphic board 40a disposed on the surface of the light guide plate 20, producing graphics that can give a high level of a visual feeling of aesthetic appreciation. Further, when linear arrangement of a dot light source, such as a LED, is used as a light source, an interference effect of finer light can be produced by combining the colors of the respective dot light sources themselves.

Opaque or black thin boards 30 are formed on light guide plate interior walls 22 so that the inside of a structure is precluded from being seen externally and shining graphics can be monitored over a black background color, making the graphic board 40 look better.

In FIG. 2, the graphic board 40 disposed on a light guide plate exterior wall 21 is formed of a transparent board material, which is the same as that of the light guide plate 20. The graphic board 40 is welded to the light guide plate exterior wall 21, so that a part of light energy, which travels the light guide plate, enters the inside of the graphic board 40. Thus, diffused reflection occurs on roughly cut sections 41,42 and a surface 43 of a roughly processed graphic board 40, and both the attached graphic side and the surface emit light, so that graphics are shined in a three-dimensional manner.

In this case, a method of roughly processing the surface of a smooth graphic board 40 can include fabricating a rough surface simply and cheaply by using a spray device for giving shock with grains of sand sprayed at high speed, a method of corroding the surface of the light guide plate chemically, etc. However, the methods are merely reference information related to the present invention.

In the transparent graphic board 40 disposed on the surface of the light guide plate 20a shown in FIG. 2, since the sections 41,42 and a surface 43a are roughly processed as mentioned earlier, the scattering phenomenon of light occurs. If a surface 43b of a transparent graphic board 40b is not roughly processed, engravings 44 are formed on the welded surface of the graphic board 40b along the contour of the graphics, so that that part becomes prominent in order to view the graphics more clearly.

Meanwhile, in FIG. 2, a method of directly forming engravings 25 on the light guide plate 20 so that light is further emitted from the portions is indicated in the light guide plate 20d. A method of attaching a cut white film 26 is displayed in the light guide plate 20c.

That is, in both cases, both the sections 41,42 have already been roughly formed in a physical cutting process, but diffused reflection does not occur on the smooth surface 43a of the graphic board 40b that has not been roughly processed.

Thus, in order to make prominent graphics thereof, the engravings 44 are formed in the plane in which the light guide plate 20b and the graphic board 40b are welded so that diffused reflection occurring in the graphic board 40b is get joined together, producing a more beautiful visual effect.

Further, the scattering phenomenon of light at the sections 41, 42 is more strongly influenced by light energy that is incident from a long way off from the section. When the colors of the light sources disposed on both sides of the light guide plate 20 differ, color light emitted from the sections 41, 42 are seen differently according to a viewing angle, giving a more conspicuous visual effect.

Another method of installing graphics in FIG. 2 is described below. A method of forming the engravings 44 in graphics that have been widely used is indicated by the light guide plate 20d. As disclosed in Korean Patent Registration No. 168711, a method of cutting graphics on the interior wall 22 of the light guide plate 20c by using the white film 26 on which an adhesive is coated is also indicated in the light guide plate 20c.

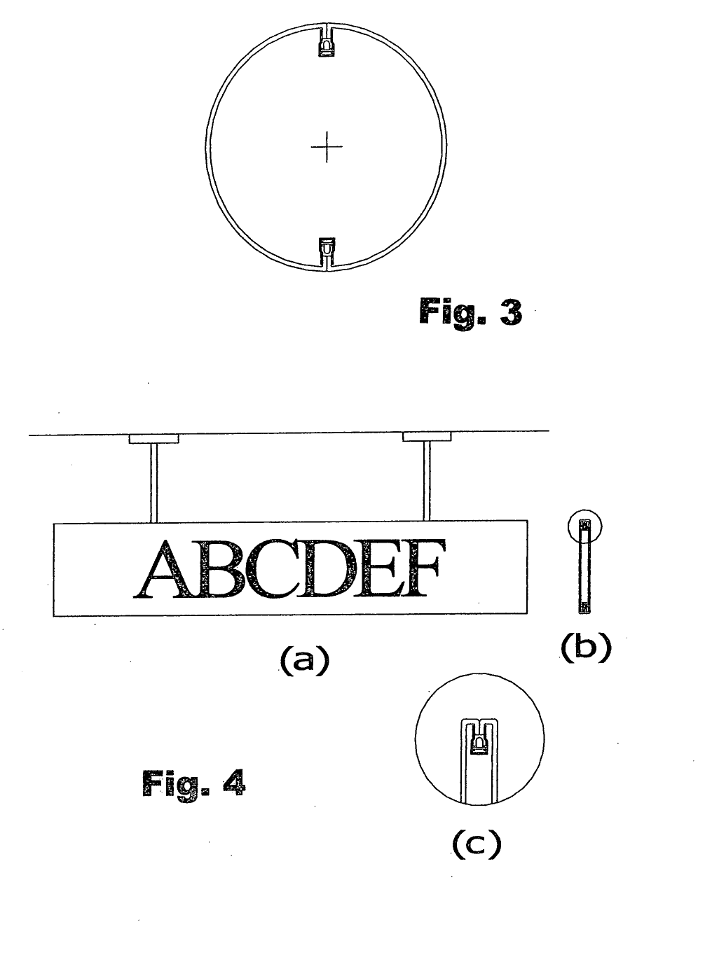

FIG. 3 is a cross-sectional view of an edge lighted display system having multiple display faces, which has a group of two light sources (LEDs) and two sheets of light guide plates of a curved surface and has as a whole the same shape as that of a cylindrical illumination structure according to still another embodiment of the present invention. FIG. 4 illustrates a state where character graphics are installed on the wall surface and hung from the ceiling in an edge lighted display system having multiple display faces in which a group of two linear light sources (LEDs) and two sheets of light guide plats having a plane are combined in accordance with an application of the present invention.

As shown in FIG. 3, two sheets of curved light guide plates 70 or two LED light source assemblies 71 that are arranged in a straight line can be combined and graphics can be installed, forming a cylindrical display structure.

Furthermore, as shown in FIG. 4, in the event that two sheets of plane light guide plates 80 and two light sources (LED strips) 81 are employed, a thin three-dimensional display system having two emitting display surfaces can be produced.

Further, if graphics are attached to the display system, both the roles of a beautiful signboard and a decorative illumination structure can be obtained, and the display system can be applied to various fields.

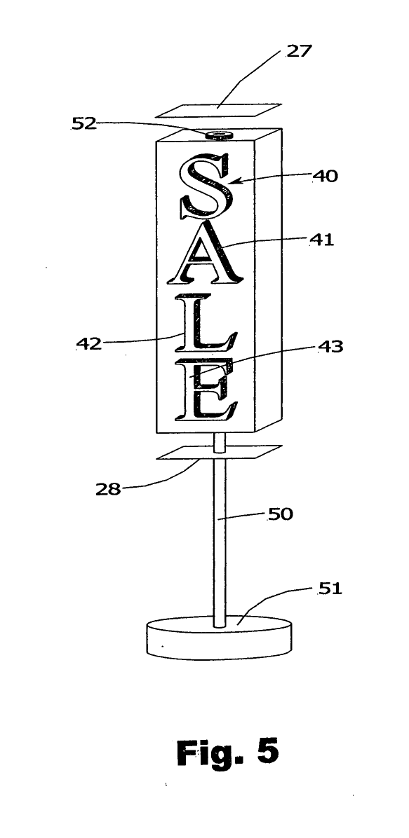

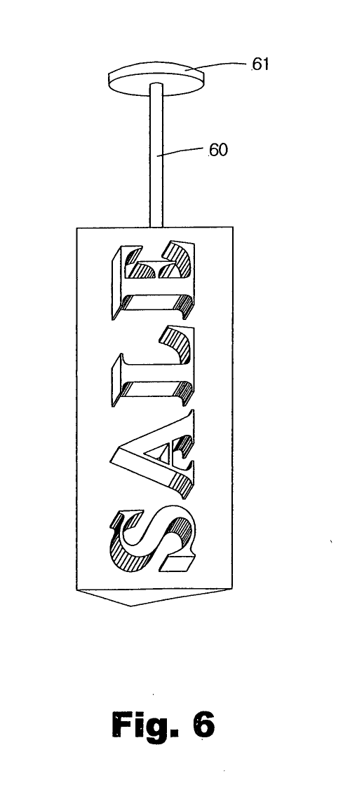

FIG. 5 is a perspective view showing a state where a transparent graphic board welded to the surface of a light guide plate looks better while rotating the whole edge lighted display system having multiple display faces formed of one square pillar-shaped three-dimensional structure in accordance with another application of the present invention.

In an edge lighted display system having multiple display faces in which a square pillar-shaped three-dimensional structure is formed, covering plates 27, 28 are securely mounted on the top and bottom of the system in order to reinforce the structure. A support tube 50 is installed at the center of the system in order to support gravity and a bottom stand 51 is installed at the bottom of the support tube 50.

In FIG. 5, an electrical rotation driving mechanism 52 for rotating the display system can be disposed at the top of the support tube 50.

Not only an electric motor and a decelerator, driven by electrical energy, but also a slip ring unit for maintaining an electrical contact while being rotated are built within the electrical rotation driving mechanism 52. Regarding power supplied through an electrical wire, an electrical wire is connected to the rotation driving structure 52 via the support tube 50.

FIG. 6 is a perspective view showing a state where an edge lighted display system having multiple display faces formed of a triangular pillar-shaped three-dimensional structure is hung from the ceiling according to still another embodiment of the present invention.

In FIG. 6, a suspension tube 60 is installed at the center of a square pillar-shaped edge lighted display system having multiple display faces structure, and a triangular pillar-shaped three-dimensional display system is hung from the ceiling by a pendant cup 61.

If a [symbol] -shaped bracket is used, the system can be installed on the wall surface together with a general illumination lighting device.

As described above in detail, the edge lighted display system having multiple display faces according to the present invention is robust in structure since it has a three-dimensional shape having one or more light guide plates unlike a conventional edgelit structure in which graphics could be seen on one plane. Further, the edge lighted display system having multiple display faces can be easily installed like a general illumination structure. Accordingly, there is an advantage in that a direction where graphics can be seen is increased several times and a region that can be monitored is widened.

Furthermore, a portion having an emission structure built therein is precluded from a visual field and more beautiful graphics can be monitored within an emitting contour through a combination of diffused reflection due to the interference of various colors. Accordingly, there is an advantage in that the edge lighted display system having multiple display faces can serve as both a beautiful illumination structure and a beautiful advertisement medium.

In addition, the whole system has one three-dimensional shape. Accordingly, there is an advantage in that the whole system can be hung from the ceiling or installed on a wall surface or a horizontal plane in various ways like a general illumination structure.

The whole system can be rotated by combining a rotation mechanism therewith. Accordingly, there is an advantage in that a plurality of graphics installed on many-sided surfaces can be monitored from several directions.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An edge lighted display system having multiple display faces, comprising:
a plurality of light guide plates respectively having both sides bent at a predetermined angle;
a cylindrical or polyhedral pillar-shaped three-dimensional structure formed by bent distal ends of the light guide plates;
LED light source assemblies linearly arranged at the ends of the junctions of the light guide plates, so that light energy from light sources can be incident on two sheets of the light guide plates simultaneously;
covering plates securely mounted on top and bottom surfaces of a three-dimensional structure formed by interconnecting the plurality of light guide plates;
a thin opaque or black board disposed on an inner wall surface of the light guide plate; and
thin transparent graphic elements adhered on an outer wall surface of the light guide plate.

2. The edge lighted display system having multiple display faces of claim 1, wherein each of the LED light source assembly is formed by having a linear tubular light source built in a housing.

3. The edge lighted display system having multiple display faces of claim 1, wherein the LED light source assembly is formed by mounting a clip on a PCB in which the light source is installed and coupling the PCB to the junction of the light guide plate.

4. The edge lighted display system having multiple display faces of claim 1, wherein engravings are formed in a part of an inner surface of the light guide plate.

5. The edge lighted display system having multiple display faces of claim 1, wherein the graphics are tailored to a transparent board having the same or similar to that of the light guide plate and then welded to the exterior wall of the light guide plate.

6. The edge lighted display system having multiple display faces of claim 5, wherein the graphics are adhered to the exterior wall of the light guide plate, in which engravings are formed in a three-dimensional manner.

7. The edge lighted display system having multiple display faces of claim 5, wherein the graphics have a front surface or both sides partially roughly processed so that diffused reflection is generated on the processed surface.

8. The edge lighted display system having multiple display faces of claim 1, wherein a support tube in which a lead wire for transferring electrical energy is built is installed at the center of the three-dimensional structure comprised of the light guide plates, thereby facilitating installation or construction.

9. The edge lighted display system having multiple display faces of claim 1, wherein an electrical rotation driving mechanism is installed at a support tube for supporting weight of the three-dimensional structure so that the electrical rotation driving mechanism can be rotated.
